(19) United States
(12) Patent Application Publication
(10) Pub. No.: US 2012/0194641 A1
(43) Pub. Date: Aug. 2, 2012

(54) THREE-DIMENSIONAL MEASURING APPARATUS, THREE-DIMENSIONAL MEASURING METHOD, AND PROGRAM

(75) Inventor: Takumi Kimura, Saitama (JP)

(73) Assignee: SONY CORPORATION, Tokyo (JP)

(21) Appl. No.: 13/360,995

(22) Filed: Jan. 30, 2012

(30) Foreign Application Priority Data
Feb. 1, 2011 (JP) 2011-019794

(51) Int. Cl. H04N 13/00

(52) U.S. Cl. 348/42; 348/E13.001

(57) ABSTRACT

A three-dimensional measuring apparatus includes a projecting unit that includes an illumination capable of varying illuminance and that projects a stripe to a measurement object with light from the illumination and shifts a phase of the stripe projected to the measurement object; an imaging unit which captures an image of the measurement object; and a control unit which allows the imaging unit to capture a plurality of the images by allowing the projecting unit to shift the phase of the stripe projected to the measurement object a plurality of times, extracts luminance values from the plurality of captured images, calculates an error rate in three-dimensional measurement of the measurement object based on the extracted luminance values, calculates the error rate for each illuminance by varying the illuminance of the illumination, and determines measurement illuminance for three-dimensionally measuring the measurement object based on the calculated error rate of each illuminance.

### CROSS REFERENCES TO RELATED APPLICATIONS

The present application claims priority to Japanese Priority Patent Application JP 2011-019794 filed in the Japan Patent Office on Feb. 1, 2011, the entire content of which is hereby incorporated by reference.

### BACKGROUND

The present disclosure relates to a technique of a three-dimensional measuring apparatus or the like capable of three-dimensionally measuring a measurement object using a phase shift method or the like.

Hitherto, a method of analyzing images obtained by imaging a measurement object and inspecting the quality of the measurement object has been used as a method of inspecting the quality of a measurement object such as a wiring substrate. In two-dimensional image analysis, it is difficult to detect defects such as a crack and a cavity in a measurement object in a height direction. For this reason, a method of measuring a three-dimensional shape of a measurement object through three-dimensional image analysis and inspecting the quality of the measurement object has recently been used.

As the method of measuring the three-dimensional shape of a measurement object through image analysis, a phase shift method (time stripe analysis method) which is a kind of optical cutting method is widely used (for example, see Japanese Unexamined Patent Application Publication No. 2010-175554 (paragraphs [0003] to [0005]) and Japanese Unexamined Patent Application Publication No. 2009-204373 (paragraphs [0023] to [0027])).

The principle of the phase shift method will be described. According to the phase shift method, a projecting apparatus first projects stripes of which a luminance is varied sinusoidally to the measurement object. The phase of the stripe projected to the measurement object is shifted by a predetermined phase shift amount. The phase shift is repeated a plurality of times (minimally three times and normally four times or more) until the phase of the stripe is moved by one period. When the phase of the stripe is shifted, an imaging apparatus images the measurement object to which the stripe is projected each time the phase is shifted. For example, when the phase shift amount is π/2 [rad], the phase of the stripe is shifted by 0, π/2, π, and 3π/2 and the image of the measurement object is captured at each phase. Then, a total of four images are acquired.

When the phase is shifted four times, a phase φ(x, y) at coordinates (x, y) can be calculated by extracting the luminance values of the respective pixels from four images and applying the luminance values to Equation (1) below.

φ(x, y)=Tan⁻¹ {I_{3π/2}(x, y)−I_{π/2}(x, y)/{I₀(x, y)−I_{π}(x, y)} (1)

In this equation, I₀(x, y), I_{π/2}(x, y), I_{π}(x, y), and I_{3π/2}(x, y) are the luminance values of the pixels located at the coordinates (x, y), respectively, when the phases are 0, π/2, π, and 3π/2.

When the phase φ(x, y) can be calculated, height information at the respective coordinates is acquired based on the phase φ(x, y) by the triangulation principle and the three-dimensional shape of the measurement object can be acquired.

### SUMMARY

In the phase shift method, as expressed in the right side of Equation (1), when the phase φ(x, y) at the coordinates (x, y) is calculated, it is necessary to calculate the differences between the luminance values of the pixels located at the coordinates (x, y).

For example, when an illumination of the projecting apparatus is too dark, the differences between the luminance values extracted from the four images decrease, and thus the phase φ(x, y) may not exactly be calculated by Equation (1). As a consequence, a problem may arise in that the three-dimensional shape of the measurement object may not exactly be measured.

On the contrary, when the illumination of the projecting apparatus is too bright, the differences between the luminance values may not exactly be calculated due to, for example, the reason why the luminance values of the pixels located in a bright portion of the stripe projected to the measurement object exceed a recognition range of the imaging apparatus. Therefore, as in the case where the illumination of the projecting apparatus is dark, a problem may arise in that the three-dimensional shape of the measurement object may not exactly be measured.

It is desirable to provide a technique of a three-dimensional measuring apparatus or the like capable of three-dimensionally measuring a measurement object using appropriate measurement illuminance.

According to an embodiment of the present disclosure, there is provided a three-dimensional measuring apparatus including a projecting unit, an imaging unit, and a control unit.

The projecting unit includes an illumination capable of varying illuminance. The projecting unit projects a stripe to a measurement object with light from the illumination and shifts a phase of the stripe projected to the measurement object.

The imaging unit captures an image of the measurement object to which the stripe is projected.

The control unit allows the imaging unit to capture a plurality of the images by allowing the projecting unit to shift the phase of the stripe projected to the measurement object a plurality of times, extracts luminance values from the plurality of captured images, calculates an error rate in three-dimensional measurement of the measurement object based on the extracted luminance values, calculates the error rate for each illuminance by varying the illuminance of the illumination, and determines measurement illuminance for three-dimensionally measuring the measurement object based on the calculated error rate of each illuminance.

The three-dimensional measuring apparatus can calculate the error rate for each illuminance in the three-dimensional measurement by varying the illuminance of the illumination and can determine the measurement illuminance for three-dimensionally measuring the measurement object based on the error rate of each illuminance. Accordingly, the three-dimensional measuring apparatus can three-dimensionally measure the measurement object with the appropriate measurement illuminance in which the calculated error rate is small, when three-dimensionally measuring the measurement object by shifting the phase of the stripe projected to the measurement object.

In the three-dimensional measuring apparatus, the measurement object may include a first region and a second region where the error rate is different from that of the first region.

In this case, the control unit calculates first and second error rates, which are the error rates of the first and second regions, respectively, for each illuminance by varying the illuminance of the illumination and determines the measurement illuminance based on the calculated first and second error rates of each illuminance.

Thus, the appropriate measurement illuminance can be determined when the measurement object including the plurality of regions where the error rates are different from each other is three-dimensionally measured.

In the three-dimensional measuring apparatus, the control unit may calculate a sum of the first and second error rates for each illuminance and determine the measurement illuminance based on the sum of the first and second error rates of each illuminance.

In the three-dimensional measuring apparatus, the control unit may determine an illuminance range in which the sum of the first and second error rates is less than a predetermined threshold value and determine an intermediate value of the illuminance range as the measurement illuminance.

Thus, it is possible to prevent the value having a risk of a sharp variation in the error rate from being used as the measurement illuminance.

In the three-dimensional measuring apparatus, the control unit may determine the measurement illuminance based on a variation ratio of the sum of the first and second error rates to the variation in the illuminance.

Thus, it is possible to prevent the value having a risk of a sharp variation in the error rate from being used as the measurement illuminance.

In the three-dimensional measuring apparatus, the control unit may determine the illuminance for which the sum of the first and second error rates is minimum as the measurement illuminance.

In the three-dimensional measuring apparatus, the control unit may prioritize one of the first and second error rates by multiplying at least one of the first and second error rates by a weight coefficient, and then calculate the sum of the first and second error rates.

Thus, the error rates in the regions, where the error rates are important, among the plurality of regions of the measurement object can be prioritized, the sum of the error rates can be calculated, and then the measurement illuminance can be determined based on the sum of the error rates.

In the three-dimensional measuring apparatus, the control unit may calculate a difference between the illuminance values, which are extracted from the plurality of images captured by shifting the phase of the stripe and correspond to the same pixel among the plurality of images, determine whether the calculated difference between the luminance values is less than a first threshold value, and calculate a ratio of the pixels, at which the difference between the luminance values is less than the first threshold value, as the error rate.

Thus, the error rates can appropriately be calculated when the illumination is too dark and the illuminance of the illumination is thus not appropriate.

In the three-dimensional measuring apparatus, the control unit may determine whether at least one of the luminance values, which are extracted from the plurality of images and correspond to the same pixel among the plurality of images, is equal to or greater than a second threshold value and calculate a ratio of the luminance values equal to or greater than the second threshold value as the error rate.

Thus, the error rates can appropriately be calculated when the illumination is too bright and the illuminance of the illumination is thus not appropriate.

In the three-dimensional measuring apparatus, the control unit may determine whether at least one of the luminance values, which are extracted from the plurality of images captured by shifting the phase of the stripe and correspond to the same pixel among the plurality of images, is equal to or greater than a predetermined threshold value and calculate a ratio of the luminance values equal to or greater than the threshold value as the error rate.

Thus, the error rates can appropriately be calculated when the illumination is too bright and the illuminance of the illumination is thus not appropriate.

According to another embodiment of the present disclosure, there is provided a three-dimensional measuring method including: projecting a stripe to a measurement object with light from an illumination capable of varying illuminance of the light.

A plurality of images are captured by shifting a phase of the stripe projected to the measurement object a plurality of times.

Luminance values are extracted from the plurality of captured images.

An error rate is calculated in three-dimensional measurement of the measurement object based on the extracted luminance values.

The error rate is calculated for each illuminance by varying the illuminance of the illumination.

Measurement illuminance for three-dimensionally measuring the measurement object is determined based on the calculated error rate of each illuminance.

According to still another embodiment of the present disclosure, there is provided a program causing a three-dimensional measuring apparatus to perform projecting a stripe to a measurement object with light from an illumination capable of varying illuminance of the light.

The three-dimensional measuring apparatus perform capturing a plurality of images by shifting a phase of the stripe projected to the measurement object a plurality of times.

The three-dimensional measuring apparatus performs extracting luminance values from the plurality of captured images.

The three-dimensional measuring apparatus performs calculating an error rate in three-dimensional measurement of the measurement object based on the extracted luminance values.

The three-dimensional measuring apparatus performs calculating the error rate for each illuminance by varying the illuminance of the illumination.

The three-dimensional measuring apparatus performs determining measurement illuminance for three-dimensionally measuring the measurement object based on the calculated error rate of each illuminance.

As described above, according to the embodiments of the present disclosures, it is possible to provide the technique of the three-dimensional measuring apparatus or the like capable of three-dimensionally measuring the measurement object using the appropriate measurement illuminance.

Additional features and advantages are described herein, and will be apparent from the following Detailed Description and the figures.

### BRIEF DESCRIPTION OF THE FIGURES

FIG. 1 is a diagram illustrating a three-dimensional measuring apparatus according to an embodiment of the present disclosure;

FIG. 2 is a flowchart illustrating an operation of the three-dimensional measuring apparatus;

FIG. 3 is a diagram illustrating an example a two-dimensional image of a substrate displayed on the screen of a display unit;

FIG. 4 is a diagram illustrating the irradiation states of a stripe projected to the substrate;

FIG. 5 is a flowchart illustrating a process of calculating an error rate;

FIG. 6 is a graph illustrating the stripe and luminance values of a vertical direction when the phases of the stripe projected to the substrate are 0, π/2, π, and 3π/2;

FIG. 7 is a graph illustrating the stripe and luminance values of a vertical direction when the phases of the stripe projected to the substrate are 0, π/2, π, and 3π/2;

FIG. 8 is a graph illustrating the stripe and luminance values of a vertical direction when the phases of the stripe projected to the substrate are 0, π/2, π, and 3π/2;

FIG. 9 is a flowchart illustrating a process of determining measurement illuminance of the projecting unit;

FIG. 10 is a diagram illustrating a relationship between the illuminance of the projecting unit and an error rate of the substrate selection region and the solder selection region;

FIG. 11 is a diagram illustrating a relationship among the illuminance of the projecting unit, the error rate of the solder selection region, the error rate of the substrate selection region, and a sum of the error rates of the substrate selection region and the solder selection region;

FIG. 12 is a diagram illustrating a relationship between the illuminance of the projecting unit and the error rates of the substrate selection region and the solder selection region;

FIG. 13 is a diagram illustrating a relationship among the illuminance of the projecting unit, the error rate of the solder selection region, the error rate of the substrate selection region, and a sum of the error rates of the substrate selection region and the solder selection region;

FIG. 14 is a flowchart illustrating a process of determining the measurement illuminance while avoiding a value having a risk of a sharp variation in the error rate; and

FIG. 15 is a flowchart illustrating another process of determining the measurement illuminance while avoiding a value having a risk of a sharp variation in the error rate.

### DETAILED DESCRIPTION

Hereinafter, an embodiment of the present disclosure will be described with reference to the drawings.

### General Configuration of Three-Dimensional Measuring Apparatus

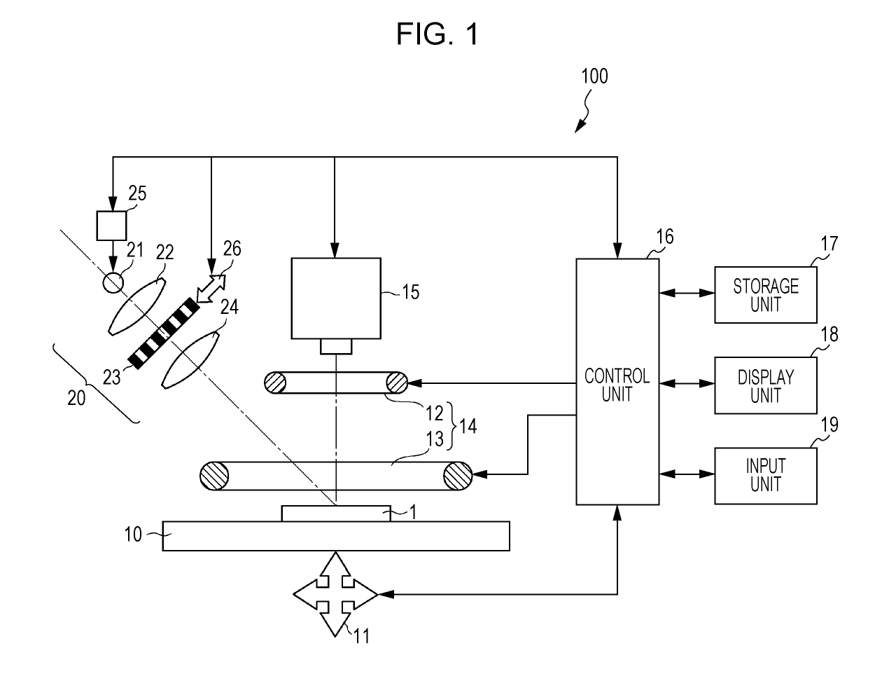

FIG. 1 is a diagram illustrating a three-dimensional measuring apparatus 100 according to an embodiment of the present disclosure. As shown in FIG. 1, the three-dimensional measuring apparatus 100 includes a stage 10 on which a measurement object 1 is placed, a projecting unit 20, an imaging unit 15, a two-dimensional image acquiring illumination unit 14, a control unit 16, a storage unit 17, a display unit 18, and an input unit 19.

The stage 10 is connected to a stage moving mechanism 11 that is driven to move the stage 10. The stage moving mechanism 11 is electrically connected to the control unit 16 and moves the stage 10 in XYZ directions in response to a driving signal from the control unit 16.

The projecting unit 20 includes a light source 21 that serves as an illumination capable of varying illuminance, a condensing lens 22 that condense light from the light source 21, a diffraction grating 23 that diffracts the light condensed by the condensing lens 22, and a projecting lens 24 that projects the light diffracted by the diffraction grating 23 to the measurement object 1.

Examples of the light source 21 include a halogen lamp, a xenon lamp, a mercury lamp, and an LED (Light Emitting Diode), but the kinds of light source 21 is not particularly limited. The light source 21 is electrically connected to an illuminance adjusting mechanism 25. The illuminance adjusting mechanism 25 adjusts the illuminance of the light source 21 under the control of the control unit 16.

The diffraction grating 23, which includes a plurality of slits, diffracts the light from the light source 21 and projects a stripe of which luminance is varied sinusoidally to the measurement object 1. The diffraction grating 23 is provided with a grating moving mechanism 26 that moves the diffraction grating 23 in a direction perpendicular to a direction in which the slits are formed. The grating moving mechanism 26 moves the diffraction grating 23 under the control of the control unit 16 and shifts the phase of the stripe projected to the measurement object 1. A liquid crystal grating or the like that displays a grating-shaped stripe may be used instead of the diffraction grating 23 and the grating moving mechanism 26.

The two-dimensional image acquiring illumination unit 14 irradiates the measurement object 1 with light, when the imaging unit 15 acquires the two-dimensional image of the measurement object 1 displayed on the screen of the display unit 18. The two-dimensional image acquiring illumination unit 14 includes two illuminations, that is, an upper illumination 12 and a lower illumination 13 having a circular shape.

The imaging unit 15 includes an imaging element such as a CCD (Charge Coupled Device) sensor or a CMOS (Complementary Metal Oxide Semiconductor) sensor and an optical system such as an image forming lens forming the light from the measurement object 1 on an imaging surface of the imaging element. The imaging unit 15 images the measurement object 1, to which the sinusoidal stripe is projected by the projecting unit 20, to three-dimensionally measure the measurement object 1. The imaging unit 15 images the measurement object 1 to acquire the two-dimensional image displayed on the display unit 18, while the two-dimensional image acquiring illumination unit 14 irradiates the measurement object 1 with the light.

The display unit 18 is configured by, for example, a liquid crystal display. The display unit 18 displays the two-dimensional image or the three-dimensional image of the measurement object 1 under the control of the control unit 16. The input unit 19 is configured by a keyboard, a mouse, a touch panel, or the like. The input unit 19 inputs an instruction from a user.

The storage unit 17 includes a non-volatile memory such as a ROM (Read Only Memory) storing various kinds of programs necessary for the process of the three-dimensional measuring apparatus 100 and a volatile memory such as a RAM (Random Access Memory) used as a working area of the control unit 16.

The control unit 16 is configured by, for example, a CPU (Central Processing Unit). The control unit 16 controls the three-dimensional measuring apparatus 100 on the whole based on the various kinds of programs stored in the storage unit 17. For example, the control unit 16 controls the illuminance adjusting mechanism 25 to adjust the illuminance of the projection unit 20 or controls the grating moving mechanism 26 to shift the phase of the stripe projected to the measurement object 1. The control unit 16 controls the imaging unit 15 such that the imaging unit 15 captures the images of the measurement object 1 to which the stripe is projected and three-dimensionally measures the measurement object 1 by a phase shift method based on the captured images. The control of the control unit 16 will be described in detail later.

In this embodiment, a substrate 1 on which solder for soldering a mounted component is formed will be described as an example of the measurement object 1. The user inspects the printed state of the solder formed on the substrate 1 by three-dimensionally measuring the substrate 1 using the three-dimensional measuring apparatus 100.

### Description of Operation

Next, an operation of the three-dimensional measuring apparatus 100 will be described.

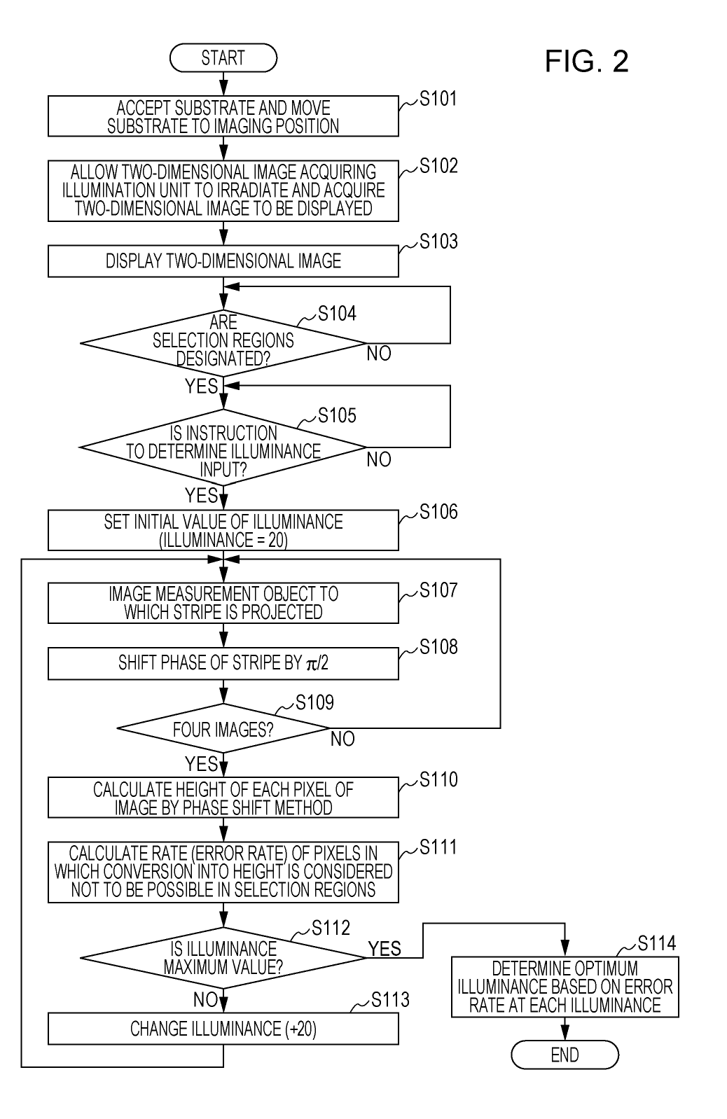

FIG. 2 is a flowchart illustrating the operation of the three-dimensional measuring apparatus 100.

First, the control unit 16 of the three-dimensional measuring apparatus 100 controls the stage moving mechanism 11 such that the stage moving mechanism 11 moves the stage 10 up to the acceptance position of the substrate 1. The stage moving mechanism 11 accepts the substrate 1 from a substrate delivering device (not shown) and moves the stage 10 to move the substrate 1 up to an imaging position (S101).

Next, the control unit 16 allows the two-dimensional image acquiring illumination unit 14 to irradiate the substrate 1 and allows the imaging unit 15 to image the substrate 1 while the two-dimensional image acquiring illumination unit 14 irradiates the substrate 1 (S102). Then, the control unit 16 acquires a two-dimensional image to be displayed.

When the control unit 16 acquires the two-dimensional image, the control unit 16 displays the acquired two-dimensional image on the screen of the display unit 18 (S103).

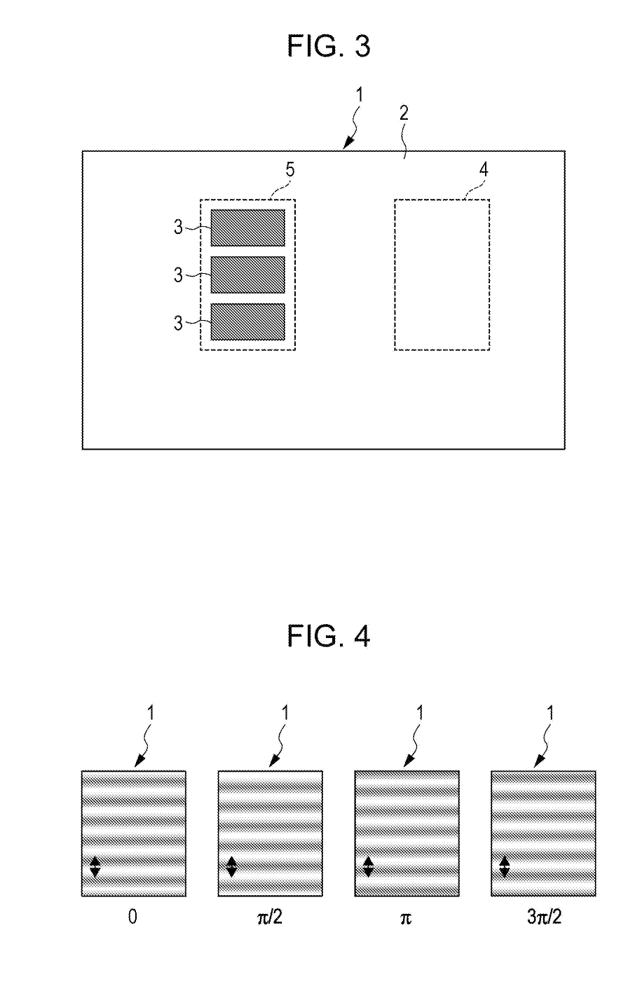

FIG. 3 is a diagram illustrating an example of the two-dimensional image displayed on the screen of the display unit 18. As shown in FIG. 3, the substrate 1 which is the measurement object 1 has a substrate region 2 (first region) and solder-formed regions 3 (second region) where a solder is formed.

When the two-dimensional image is displayed on the display unit 18, the user designates a substrate selection region 4 and a solder selection region 5 in the substrate regions 2 and the solder-formed regions 3 through the input unit 19, while viewing the image displayed on the display unit 18.

Here, in a case where the individual solder-formed region 3 is minute, the number of pixels, which is a parameter at the time of calculating an error rate subsequently in three-dimensional measurement, decreases when only the solder-formed regions 3 are selected. Therefore, when the solder-formed regions 3 are minute, the user may designate the solder selection region 5 surrounding the plurality of solder-formed regions 3 in a portion in which the solder-formed regions 3 are dense.

Referring back to FIG. 2, when the two-dimensional image of the substrate 1 is displayed on the screen of the display unit 18, the control unit 16 determines whether the substrate selection region 4 and the solder selection region 5 are designated (S104). When the selection regions are designated (YES in S104), the control unit 16 determines whether the user inputs an instruction to determine the illuminance through the input unit 19 (S105).

When the user inputs the instruction to determine the illuminance through the input unit 19 (YES in S105), the control unit 16 controls the illuminance adjusting mechanism 25 such that the illuminance adjusting mechanism 25 sets the illuminance of the light source 21 to the initial value (for example, 20) (S106). When the illuminance of the light source 21 is set to the initial value, the projecting unit 20 projects a stripe to the substrate 1. Next, the control unit 16 allows the imaging unit 15 to capture the image of the substrate 1 to which the stripe is projected (S107).

Next, the control unit 16 controls the grating moving mechanism 26 such that the grating moving mechanism 26 moves the diffraction grating 23, so that the phase of the stripe projected to the substrate 1 is shifted by π/2 [rad] (S108). When the phase of the stripe is shifted, the control unit 16 subsequently determines whether four images are captured with the same illuminance (S109).

When the four images are not captured with the same illuminance (NO in S109), the control unit 16 returns the process to S107 and allows the imaging unit 15 to image the substrate 1 to which the stripe is projected. In this way, a total of four images for which the phases of the stripe are different from each other are captured with the same illuminance.

FIG. 4 is a diagram illustrating the irradiation states of the stripe. FIG. 4 shows the irradiation states of the stripe when the phases of the stripe are 0, π/2, π, and 3π/2 sequentially from the left side.

When the fourth image of the substrate 1 is captured with the same illuminance with reference to FIG. 2 (YES in S109), the control unit 16 calculates the height of each pixel of the image by the phase shift method based on the four images (S110).

In this case, the control unit 16 extracts the luminance value of each pixel (coordinates (x, y)) from the four images and calculates the phase φ(x, y) of each pixel by applying Equation (2) below. Then, the control unit 16 calculates the height of each pixel by the triangulation principle based on the calculated phase φ(x, y) of each pixel.

Equation (2) below is the same as Equation (1) described above and I₀(x, y), I_{π/2}(x, y), I_{π}(x, y), and I_{3π/2}(x, y) are the luminance values of the pixels (coordinates), respectively, when the phases of the stripe are 0, π/2, π, and 3π/2.

φ(x, y)=Tan⁻¹{I_{3π/2}(x, y)−I_{π/2}(x, y)}/{I₀(x, y)−I_{π}(x, y)} (2)

Here, when the luminance value is converted into the height, the conversion into the height based on the phase φ(x, y) is not possible in the pixel under a predetermined condition and the pixel is considered as an error.

When the luminance value of each pixel is converted into the height of each coordinate, the control unit 16 subsequently calculates the rate (error rate) of the pixels in which the conversion into the height is not possible in the substrate selection region 4 and the solder selection region 5 (S111).

The condition under which the conversion into the height based on the phase φ(x, y) is not possible or the method of calculating the rate (error rate) of the pixels in which the conversion into the height is not possible will be described in detail later.

When the error rate is calculated, the control unit 16 subsequently determines whether the illuminance of the current projecting unit 20 is the maximum value (for example, 240) (S112). When the illuminance of the projecting unit 20 is not the maximum (NO in S112), the control unit 16 changes the illuminance of the projecting unit 20 (for example, the illuminance +20) (S113).

Then, the control unit 16 returns the process to S107 and captures four images of the substrate 1 again by imaging the substrate 1 to which the stripe is projected with the changed illuminance. When the four images are captured, the height of each pixel (each coordinate) is calculated by the phase shift method and the error rate is calculated with the changed illuminance. The series of processes are repeated until the illuminance of the projecting unit 20 becomes the maximum.

When the illuminance of the projecting unit 20 is the maximum (YES in S112), the control unit 16 determines the measurement illuminance in the three-dimensional measurement based on the error rate in the selection regions 4 and 5 at each illuminance (S114). In this case, for example, the illuminance at which the error rate of the selection regions 4 and 5 is the minimum is determined as the measurement illuminance. Further, the method of determining the measurement illuminance will be described in detail below.

When the measurement illumination is determined, the control 16 stores the measurement illuminance in the storage unit 17. When the measurement illuminance is determined, the determined measurement illuminance may be displayed on the display unit 18. Thus, the user can view the optimum illuminance to three-dimensionally measure the substrate 1.

The user inputs the illuminance displayed on the display unit 18 into the three-dimensional measuring apparatus 100 through the input unit 19 to set the illuminance of the projecting unit 20. When the measurement illuminance is determined, the control unit 16 may automatically set the determined measurement illuminance.

In order to acquire the images of the substrate 1 subsequent to the second image and having the same configuration as that of the first image of the substrate 1, the projecting unit 20 projects the stripe to the substrate 1 with the determined measurement illuminance. Three-dimensional information regarding the substrate 1 is calculated based on the four images captured with the illuminance and the three-dimensional image of the substrate 1 is displayed on the screen of the display unit 18. The user views the three-dimensional image displayed on the screen of the display unit 18 and inspects the printed states of the solders formed on the substrate 1.

Referring to FIG. 2, the case has been described in which the user designates the substrate selection region 4 and the solder selection region 5 while viewing the images of the substrate 1 displayed on the screen of the display unit 18. However, this process may automatically be performed by the control unit 16. That is, the control unit 16 may analyze the two-dimensional image acquired in S103, may determine the substrate region 2 and the solder-formed regions 3, and may designate the substrate selection region 4 and the solder selection region 5 from the substrate region 2 and the solder-formed regions 3.

Referring to FIG. 2, the case has been described in which the initial value of the illuminance of the projecting unit is set to 20, the illuminance is varied by +20 at each time, and the illuminance is varied up to the maximum value 240. On the other hand, the repeated step width may initially be set to be large (for example, +50), the initial value and the maximum value of the illuminance may be reset near the portion where the error rate may be decreased, and the step width may be decreased (for example, +50→+10→+1). Thus, the measurement illuminance can be determined efficiently in detail.

### Method of Calculating Error Rate

Next, the condition under which the conversion into the height based on the phase φ(x, y) is not possible (error) and which is described in S110 and S111 of FIG. 2 or the method of calculating the rate (error rate) of the pixels in which the conversion into the height is not possible will be described in detail.

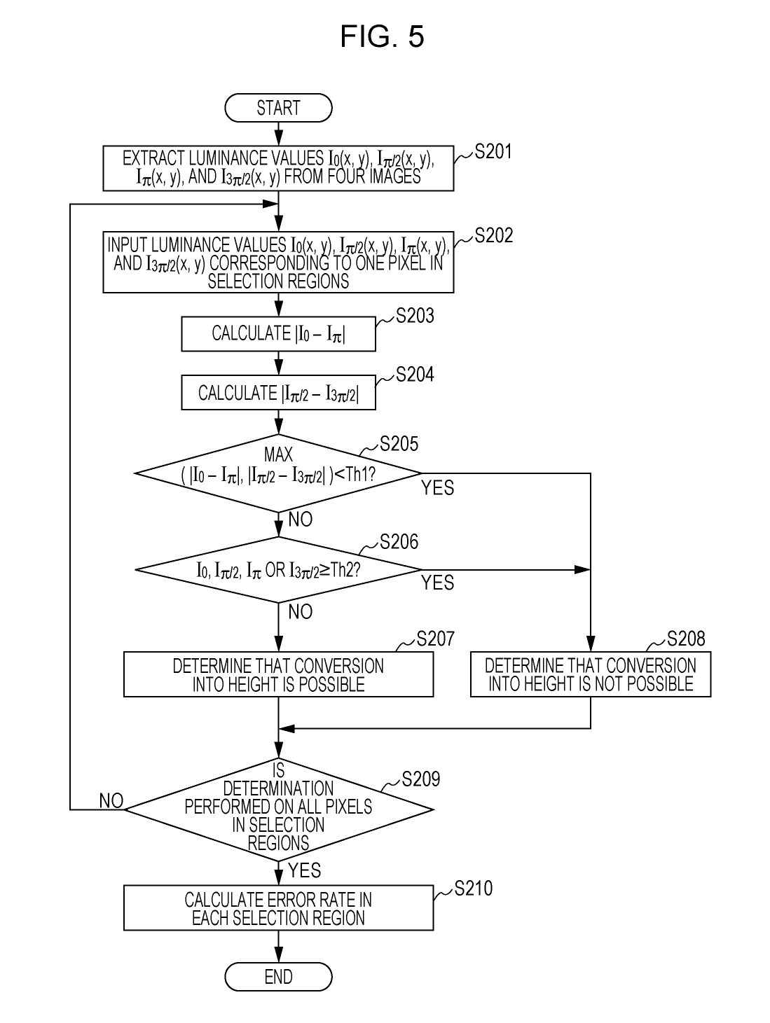

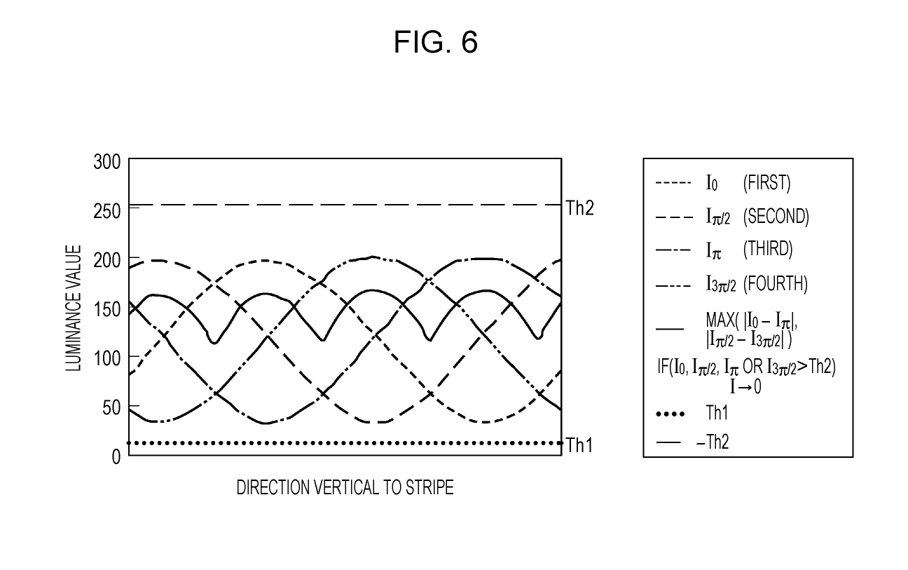

FIG. 5 is a flowchart illustrating the process of calculating the error rate. FIGS. 6, 7, and 8 are graphs illustrating the strips and luminance values of a vertical direction when the phases of the stripe projected to the substrate 1 are 0, π/2, π, and 3π/2.

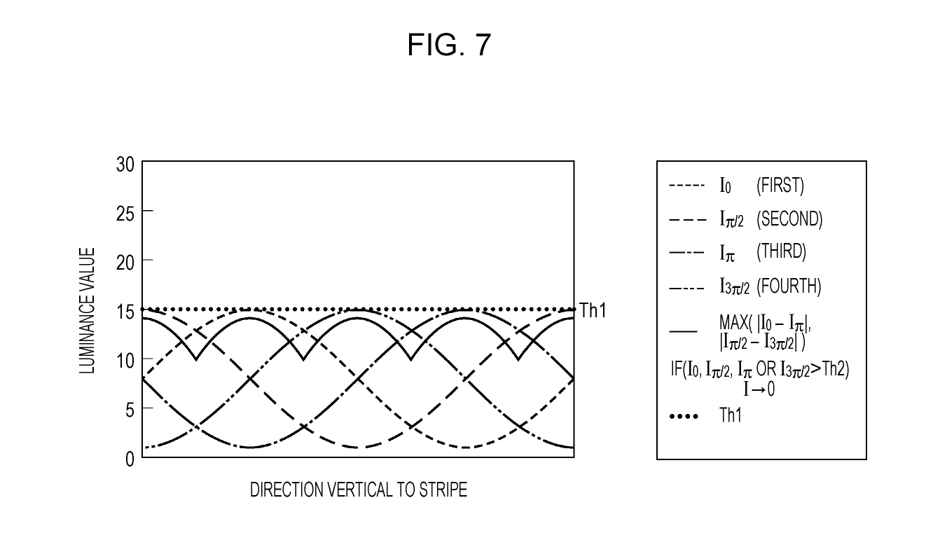

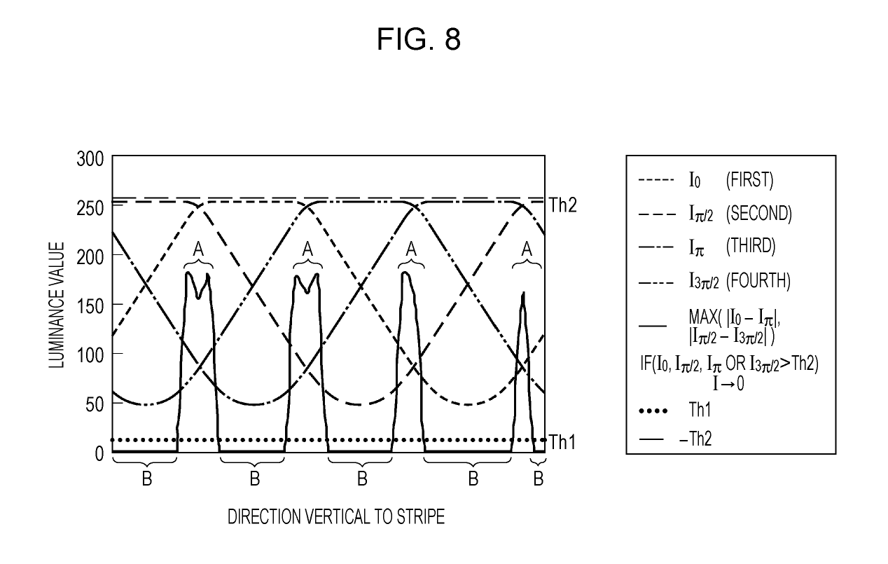

FIG. 6 shows an example of a case where the illuminance of the projecting unit 20 is appropriate. FIG. 7 shows an example of a case where the illuminance of the projecting unit 20 is too small. FIG. 8 shows an example of a case where the illuminance of the projecting unit 20 is too large.

As shown in FIG. 5, the control unit 16 extracts the luminance values I₀(x, y), I_{π/2}(x, y), I_{π}(x, y), and I_{3/π2}(x, y) of the respective pixels (respective coordinates (x, y)) in the four images which are captured with the same illuminance and in which the phases of the stripe are different from each other (S201).

Here, the luminance values may be extracted from all of the captured images or may be extracted from all of the substrate selection region 4 and the solder selection region 5 (see FIG. 3).

Next, the control unit 16 inputs the luminance values I₀(x, y), I_{π/2}(x, y), I_{π}(x, y), and I_{3/π2}(x, y) corresponding to one pixel in the substrate selection region 4 and the solder selection region 5 (S202).

Next, the control unit 16 calculates the absolute value of the difference between the luminance value I₀(x, y) of the image (first image) when the phase of the stripe is 0 and the luminance value I_{π}(x, y) of the image (third image) when the phase of the stripe is π in one pixel in the selection regions 4 and 5 (S203). Likewise, the control unit 16 calculates the absolute value of the difference between the luminance value I_{π/2}(x, y) of the image (second image) when the phase of the stripe is π/2 and the luminance value I_{3/π2}(x, y) of the image (fourth image) when the phase of the stripe is 3π/2 in one pixel in the selection regions 4 and 5 (S204).

Next, the control unit 16 determines whether a larger value between the two absolute values, that is, the absolute value of the difference between the luminance value I₀(x, y) and the luminance value I_{π}(x, y) and the absolute value of the difference between the luminance value I_{π/2}(x, y) and the luminance value I_{3π/2}(x, y) is less than a first threshold value Th1 (S205).

In S205, the control unit 16 determines whether both the two absolute values are less than the first threshold value Th1. For example, the first threshold value Th1 is 15 (see FIGS. 6 to 8).

When the larger value of the two absolute values is less than the first threshold value Th1 (YES in S205), the control unit 16 determines that the conversion into the height by the phase shift method is not possible (error) in the pixel (S208). Then, the control unit 16 allows the process to proceed to S209.

On the other hand, when the larger value of the two absolute values is equal to or greater than the first threshold value Th1 (NO in S205), the control unit 16 allows the process to proceed to S206. In S206, the control unit 16 determines whether at least one of the four luminance values I₀(x, y), I_{π/2}(x, y), I_{π}(x, y), and I_{3π2}(x, y) is equal to or greater than a second threshold value Th2. The second threshold value Th2 is 256 (see FIGS. 6 and 7).

When at least one of the four luminance values is equal to or greater than a second threshold value Th2 (YES in S206), the control unit 16 determines that the conversion into the height based on the luminance values is not possible (error) (S208) and the process proceeds to S209.

When all of the four luminance values are less than the second threshold value Th2 (NO in S206), the control unit 16 determines that the conversion into the height based on the luminance values is possible (S207) and the process proceeds to S209.

In S209, the control unit 16 determines whether the error determination is performed on all of the pixels in the substrate selection region 4 and the solder selection region 5.

When the undetermined pixel remains in the substrate selection region 4 and the solder selection region 5 (NO in S209), the control unit 16 returns the process to S202 and repeats the processes of S202 to S209.

On the other hand, when the determination is performed on all of the pixels contained in the substrate selection region 4 and the solder selection region 5 (YES in S209), the control unit 16 calculates the error rate in each of the substrate selection region 4 and the solder selection region 5 (S210). In this case, the control unit 16 can calculate the error rate (first error rate) of the substrate selection region 4 by dividing the number of pixels in which the error occurs in the substrate selection region 4 by the number of pixels in the entire substrate selection region 4. Likewise, the control unit 16 can calculate the error rate (second error rate) of the solder selection region 5 by dividing the number of pixels in which the error occurs in the solder selection region 5 by the number of pixels in the entire solder selection region 5.

The processes of S201 to S210 are performed whenever the illuminance of the projecting unit 20 is varied. Thus, the error rate of each selection region is calculated for each illuminance through these processes.

FIG. 6 shows an example of the case where the illuminance of the projecting unit 20 is appropriate. A solid line shown in FIG. 6 indicates a larger value between the absolute value of the difference between the luminance value I₀(x, y) and the luminance value I_{π}(x, y) and the absolute value of the difference between the luminance value I_{π/2}(x, y) and the luminance value I_{3π/2}(x, y). Further, in the solid line, the luminance value is 0, when at least one of the four luminance values is equal to or greater than the second threshold value Th2.

As indicated by the solid line in FIG. 6, the larger value between the two absolute values is equal to or greater than the first threshold value Th1 (15) in the entire region (see S205). Further, as indicated by the solid line in FIG. 6, the four luminance values are less than the second threshold value Th2 (256) in the entire region (see S206). Accordingly, in the example shown in FIG. 6, the conversion into the height is possible in the entire region, since the illuminance of the projecting unit 20 is appropriate and the differences between the luminance values are large (see S207). In the example shown in FIG. 6, the error rate is 0%.

FIG. 7 shows an example of the case where the illuminance of the projecting unit 20 is too small. As indicated by the solid line in FIG. 7, the larger value between the two absolute values is less than the first threshold value Th1 in the entire region (see S205). Accordingly, in the example shown in FIG. 7, the conversion into the height is not possible (error) in the entire region, since the illuminance of the projecting unit 20 is too small and the differences between the luminance values are small (see S208). In the example shown in FIG. 7, the error rate is 100%.

FIG. 8 shows an example of the case where the illuminance of the projecting unit 20 is too large. As indicated by the solid line in FIG. 8, the larger value between the two absolute values is equal to or greater than the first threshold value Th1 in the regions indicated by A (see S205). Further, in the regions indicated by A, at least one value among the four luminance values is not equal to or greater than the second threshold value Th2 (see S206). Accordingly, in the pixels falling within the ranges indicated by A, the conversion into the height based on the luminance values is possible (see S207).

On the other hand, in ranges indicated by B, at least one value among the four luminance values is equal to or greater the second threshold value Th2 (see S206). Accordingly, in the pixels falling within the ranges indicated by B, the conversion into the height based on the luminance values is not possible (see S208). Further, when at least one value among the four luminance values is equal to or greater than the second threshold value Th2, the luminance value exceeds the recognition range of the imaging unit 15, and thus the luminance value indicated by the solid line is 0.

As shown in FIGS. 5 to 8, in this embodiment, the error rate can appropriately be calculated by using the first and second threshold values, when the illumination is too dark or too bright and the illuminance is thus not appropriate.

### Method of Determining Illuminance of Projecting Unit 20

Next, the method of determining the measurement illuminance of the projecting unit 20, as described in S114 of FIG. 2, will be described in detail.

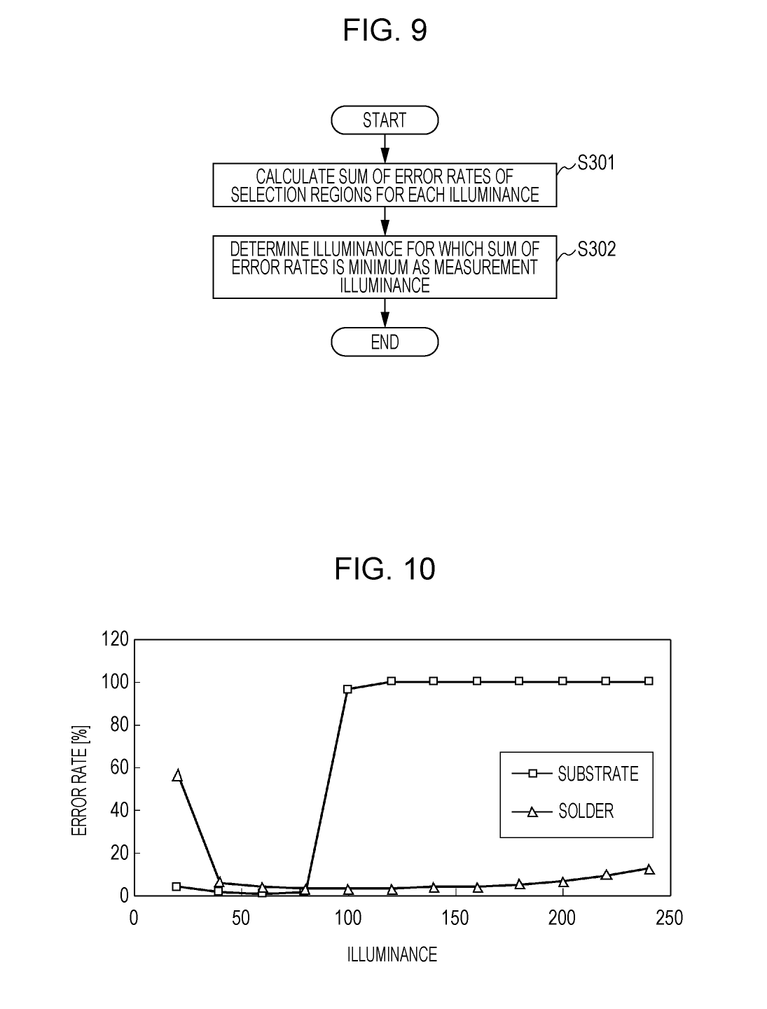

FIG. 9 is a flowchart illustrating a process of determining measurement illuminance of the projecting unit 20. As shown in FIG. 9, the control unit 16 calculates a sum of the error rate (first error rate) of the substrate selection region 4 and the error rate (second error rate) of the solder selection region 5 for each illuminance. When the control unit 16 calculates the sum of the error rates of the selection regions 4 and 5 for each illuminance, the control unit 16 determines the illuminance for which the sum of the error rates is the minimum as the measurement illuminance of the projecting unit 20 (S302).

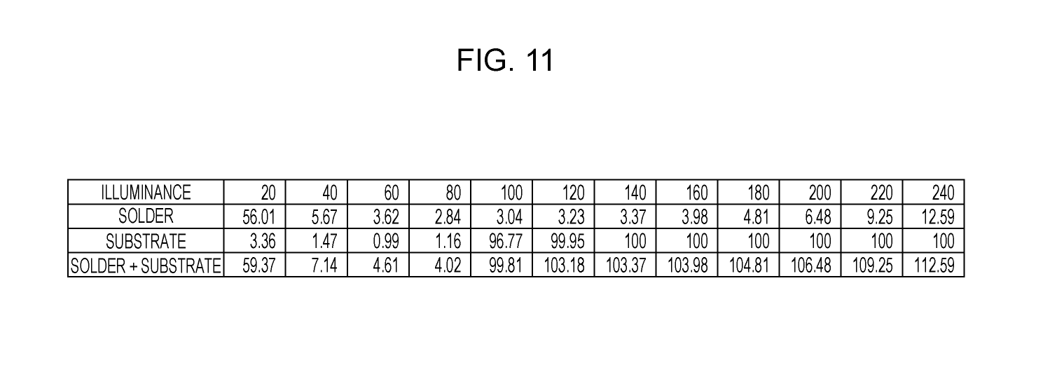

FIG. 10 is a diagram illustrating a relationship between the illuminance of the projecting unit 20 and the error rate of the substrate selection region 4 and the solder selection region 5. FIG. 11 is a diagram illustrating a relationship among the illuminance of the projecting unit 20, the error rate of the solder selection region 5, the error rate of the substrate selection region 4, and a sum of the error rates of the substrate selection region 4 and the solder selection region 5.

FIGS. 10 and 11 show an example of a case where the substrate 1 (white substrate 1) in which the substrate region 2 is white is used as the measurement object 1.

In case of the white substrate 1, as shown in FIG. 11, the sum of the error rates is 4.02% which is the minimum when the illuminance is 80. Therefore, in this case, 80 is selected as the measurement illuminance (see S302).

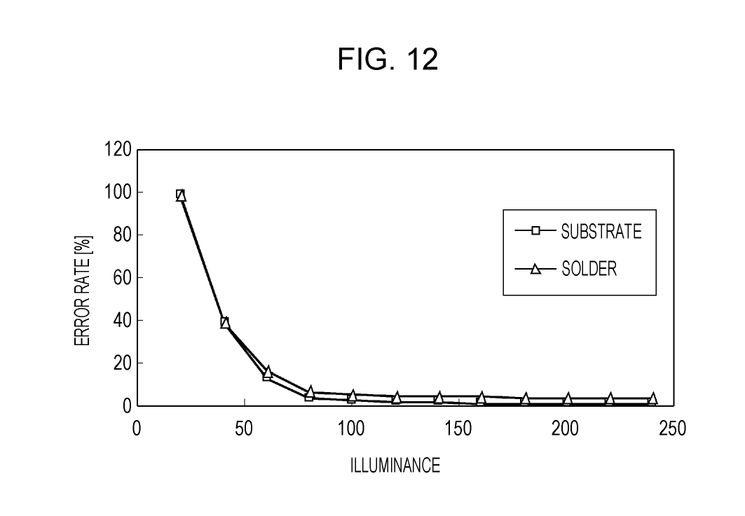

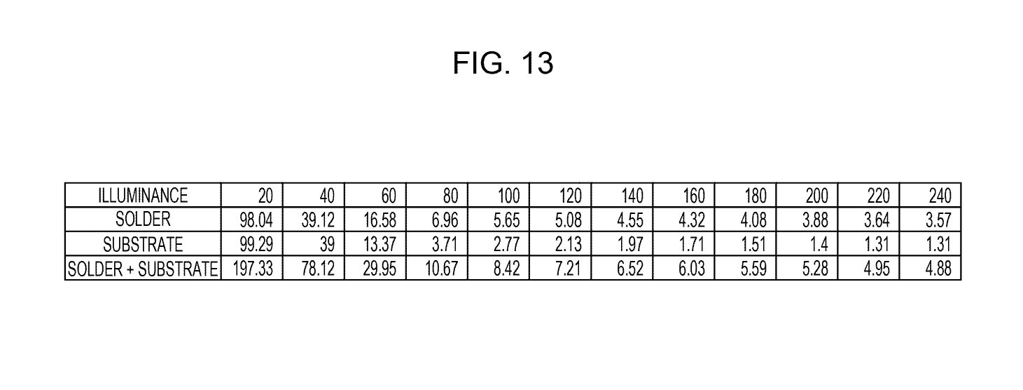

FIG. 12 is a diagram illustrating a relationship between the illuminance of the projecting unit 20 and the error rates of the substrate selection region 4 and the solder selection region 5. FIG. 13 is a diagram illustrating a relationship among the illuminance of the projecting unit 20, the error rate of the solder selection region 5, the error rate of the substrate selection region 4, and a sum of the error rates of the substrate selection region 4 and the solder selection region 5.

FIGS. 12 and 13 show an example of a case where the substrate 1 (blue substrate 1) in which the substrate region 2 is blue is used as the measurement object 1.

In the case of the blue substrate 1, as shown in FIG. 13, the sum of the error rates is 4.88% which is the minimum when the illuminance is 240. Therefore, in this case, 240 is selected as the measurement illuminance (see S302).

In this way, in the three-dimensional measuring apparatus 100 according to this embodiment, the determined measurement illuminance of the white substrate 1 is different from that of the blue substrate 1. That is, in this embodiment, since the error rate of the measurement object 1 is actually calculated and the measurement illuminance can be determined based on the error rate, the measurement illuminance appropriate depending on the kind of the substrate 1 can be determined for each kind (color) of substrate 1.

In S301 of FIG. 9, the case has been described in which the sum of the error rates of the two selection regions 4 and 5 is simply calculated. On the other hand, the control unit 16 may prioritize one of the error rates of the substrate selection region 4 and the solder selection region 5 by multiplying at least one of the error rates by a weight coefficient, and then may calculate the sum of the first and second error rates.

Here, the measurement object in the three-dimensional measurement is not the substrate region 2 but the solder-formed regions 3. The error rate of the solder selection region 5 has a significant influence on the measurement accuracy. Further, the reason for acquiring the data from the substrate region 2 in the three-dimensional measurement is to determine a reference of the height of the solder-formed regions 3. Accordingly, the mean value of the heights of the plane or data necessary for just calculating a slope suffices in the substrate region 2.

Accordingly, when the weight coefficient is used, the error rate of the solder selection region 5 is generally prioritized than the error rate of the substrate selection region 4. For example, the ratio of the weight coefficients of the solder selection region 5: the substrate selection region 4 is 6:4, 7:3, or the like.

However, when the measurement object 1 is the white substrate 1, as in FIGS. 10 and 11, the illuminance in which the sum of the error rates of the selection regions 4 and 5 is the minimum is 80. On the other hand, when the illuminance is 100, the error rate of the substrate selection region 4 sharply increases and the sum of the error rates of the selection regions 4 and 5 accordingly increases sharply as well. Accordingly, when 80 is determined as the measurement illuminance, the sum of the error rates is likely to increase sharply in a case where the measurement illuminance is deviated slightly.

Accordingly, the control unit 16 may determine the measurement illuminance while avoiding the value having a risk of a sharp variation in the error rate.

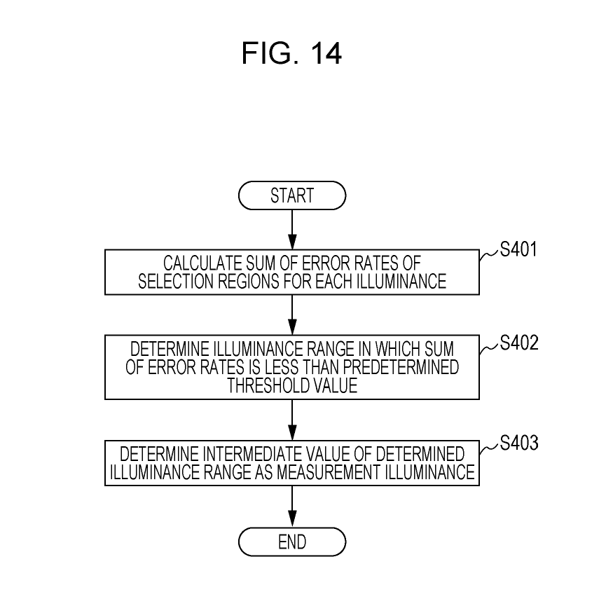

FIG. 14 is a flowchart illustrating a process of determining the measurement illuminance while avoiding a value having a risk of a sharp variation in the error rate.

As shown in FIG. 14, the control unit 16 calculates the sum of the error rate (first error rate) of the substrate selection region 4 and the error rate (second error rate) of the solder selection region 5 for each illuminance (S401). In this case, as described above, the control unit 16 may multiply at least one of the error rates of the substrate selection region 4 and the solder selection region 5 by a weight coefficient, and then may calculate the sum of the error rates.

Next, the control unit 16 determines the illuminance range in which the sum of the error rates of the selection regions 4 and 5 is less than a predetermined threshold value Th3 (for example, 15%) (S402).

Next, the control unit 16 calculates an intermediate value from the illuminance range in which the sum of the error rates is less than the threshold value Th3 and determines the intermediate value as the measurement illuminance (S403).

For example, a case will be described in which the measurement object 1 is the white substrate 1 and the error rates shown in FIGS. 10 and 11 are calculated. In this case, the illuminance range in which the sum of the error rates of the selection regions 4 and 5 is less than the threshold value Th3 (15%) is 40 to 80 (S402). Since the intermediate value of the illuminance range of 40 to 80 is 60, the control unit 16 determines 60 as the measurement illuminance (S403).

By the process shown in FIG. 14, the measurement illuminance can be determined while the value having the risk of the sharp variation in the error rate is avoided.

On the other hand, in the case where the measurement object 1 is the blue substrate 1 and the error rates shown in FIGS. 12 and 13 are calculated, the illuminance range in which the sum of the error rates of the selection regions 4 and 5 is less than the threshold value Th3 (15%) is 80 to 240 (S402). Since the intermediate value of the illuminance range of 80 to 240 is 160, the control unit 16 determines 160 as the measurement illuminance (S403).

When the measurement object 1 is the blue substrate 1, the sum of the error rates uniformly decreases with respect to the measurement illuminance. However, when the illuminance is further increased or the exposure time of the imaging unit 15 is lengthened, both the error rates of the substrate selection region 4 and the solder selection region 5 increase. Therefore, there is a possibility that the sum of the error rates may sharply increase. Accordingly, even when the measurement object 1 is not only the white substrate 1 but also the blue substrate 1, the process shown in FIG. 14 is effectively performed.

The case has hitherto been described in which the intermediate value of the illuminance for which the sum of the error rates is less than the threshold value Th3 is used as one method of preventing a value having the risk of the sharp variation in the error rate from being used as the measurement illuminance, as described above. On the other hand, a variation ratio of the sum of the error rates to the variation in the illuminance may be used as another method of preventing a value having the risk of the sharp variation in the error rate from being used as the measurement illuminance.

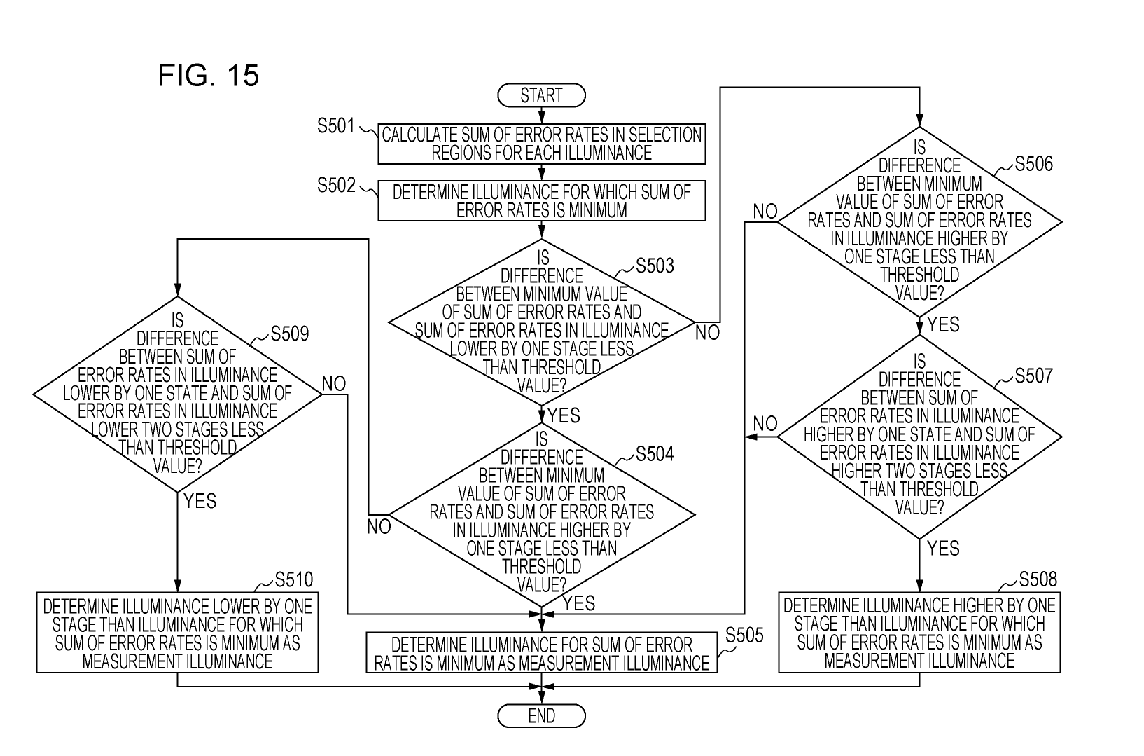

FIG. 15 is a flowchart illustrating another process of using the variation ratio of the error rate.

As shown in FIG. 15, the control unit 16 calculates the sum of the error rates of the substrate selection region 4 and the solder selection region 5 for each illuminance (S501). Next, the control unit 16 determines the illuminance for which the sum of the error rates is the minimum (S502).

Next, the control unit 16 calculates a difference between the minimum value of the sum of the error rates and the sum of the error rates in the illuminance (for example, −20) lower by one level than the illuminance for which the sum of the error rates is the minimum. That is, the control unit 16 calculates the difference in the sum of the error rates between the illuminance for which the sum of the error rates is the minimum and the illuminance lower by one level than the illuminance for which the sum of the error rates is the minimum.

Then, the control unit 16 determines whether the difference between the minimum value of the sum of the error rates and the sum of the error rates in the illuminance lower by one level than the illuminance for which the sum of the error rates is the minimum is less than a predetermined threshold value Th4 (S503). For example, the threshold value Th4 is in the range of about 5% to about 10%.

When the difference between the minimum value of the sum of the error rates and the sum of the error rates in the illuminance lower by one level is less than the predetermined threshold value Th4 (YES in S503), the control unit 16 allows the process to proceed to S504. In S504, the control unit 16 calculates a difference between the minimum value of the sum of the error rates and the sum of the error rates in the illuminance (for example, +20) higher by one level than the illuminance for which the sum of the error rates is the minimum. That is, the control unit 16 calculates the difference in the sum of the error rates between the illuminance for which the sum of the error rates is the minimum and the illuminance higher by one level than the illuminance for which the sum of the error rates is the minimum. Then, the control unit 16 determines whether the difference between the minimum value of the sum of the error rates and the sum of the error rates in the illuminance higher by one level is less than the predetermined threshold value Th4.

When the difference between the minimum value of the sum of the error rates and the sum of the error rates in the illuminance higher by one level is less than the predetermined threshold value Th4 (YES in S504), the control unit 16 determines the illuminance for which the sum of the error rates is the minimum as the measurement illuminance (S505).

When the difference between the minimum value of the sum of the error rates and the sum of the error rates in the illuminance lower by one level than the illuminance for which the sum of the error rates is the minimum is equal to or greater than the predetermined threshold value Th4 in S503 (No in S503), the control unit 16 allows the process to proceed to S506. In S506, the control unit 16 determines whether the difference between the minimum value of the sum of the error rates and the sum of the error rates in the illuminance higher by one level than the illuminance for which the sum of the error rates is the minimum is less than the predetermined threshold value Th4.

When the difference between the minimum value of the sum of the error rates and the sum of the error rates in the illuminance higher by one level is equal to or greater than the predetermined threshold value Th4 (No in S506), the control unit 16 determines the illuminance for which the sum of the error rates is the minimum as the measurement illuminance (S505).

On the other hand, when the difference between the minimum value of the sum of the error rates and the sum of the error rates in the illuminance higher by one level than the illuminance for which the sum of the error rates is the minimum is less than the predetermined threshold value Th4 (YES in S506), the control unit 16 allows the process to proceed to S507. In S507, the control unit 16 calculates a difference between the sum of the error rates in the illuminance higher by one level than the illuminance for which the sum of the error rates is the minimum and the sum of the error rates in the illuminance (for example, +40) higher by two levels. Then, the control unit 16 determines whether the difference between the sum of the error rates in the illuminance higher by one level and the sum of the error rates in the illuminance higher by two levels is less than the threshold value Th4.

When the difference between the sum of the error rates in the illuminance higher by one level and the sum of the error rates in the illuminance higher by two levels is equal to or greater than the threshold value Th4 (NO in S507), the control unit 16 determines the illuminance for which the sum of the error rates is the minimum as the measurement illuminance (S505).

On the other hand, when the difference between the sum of the error rates in the illuminance higher by one level and the sum of the error rates in the illuminance higher by two levels is less than the threshold value Th4 (YES in S507), the control unit 16 determines the illuminance higher by one level by the illuminance for which the sum of the error rates is the minimum as the measurement illuminance (S508).

When the difference between the minimum value of the sum of the error rates and the sum of the error rates in the illuminance higher by one level than the illuminance for which the sum of the error rates is the minimum is equal to or greater than the predetermined threshold value Th4 in S504 (NO in S504), the control unit 16 allows the process to proceed to S509. In S509, the control unit 16 calculates a difference between the sum of the error rates in the illuminance lower by one level than the illuminance for which the sum of the error rates is the minimum and the sum of the error rates in the illuminance (for example, −40) lower by two levels. Then, the control unit 16 determines whether the difference between the sum of the error rates in the illuminance lower by one level and the sum of the error rates in the illuminance lower by two levels is less than the threshold value Th4.

When the difference between the sum of the error rates in the illuminance lower by one level and the sum of the error rates in the illuminance lower by two levels is equal to or greater than the threshold value Th4 (NO in S509), the control unit 16 determines the illuminance for which the sum of the error rates is the minimum as the measurement illuminance (S505).

On the other hand, when the difference between the sum of the error rates in the illuminance lower by one level and the sum of the error rates in the illuminance lower by two levels is less than the threshold value Th4 (YES in S509), the control unit 16 determines the illuminance lower by one level than the illuminance for which the sum of the error rates is the minimum as the measurement illuminance (S510).

Since the measurement illuminance is determined based on the variation ratio of the sum of the error rates to the variation in the illuminance through the process shown in FIG. 14, it is possible to prevent the value having the risk of the sharp variation in the error rate from being used as the measurement illuminance.

### Operation

As described above, the three-dimensional measuring apparatus 100 according to the embodiment can calculate the error rates for each illuminance in the three-dimensional measurement by varying the illuminance of the projecting unit 20 and can determine the measurement illuminance for three-dimensionally measuring the measurement object 1 based on the calculated error rate of each illuminance. Thus, the three-dimensional measuring apparatus 100 according to the embodiment can three-dimensionally measure the measurement object 1 with the appropriate measurement illuminance such that the error rates are small (the number of effective pixels without error is large), when three-dimensionally measuring the measurement object 1.

In this embodiment, since the error rates of the measurement object 1 can actually be calculated and the measurement illuminance can be determined based on the error rates, the measurement illuminance appropriate for the kind of measurement object 1 can be determined for each kind of measurement object 1. For example, as described above, it is possible to determine the measurement illuminance appropriate for each of the white substrate 1 and the blue substrate 1.

In this embodiment, the measurement illuminance can be determined based on two error rates, that is, the error rate (first error rate) of the substrate selection region 4 and the error rate (second error rate) of the solder selection region 5. Thus, in this embodiment, the measurement illuminance appropriate in accordance with the respective error rates can be determined when the measurement object 1 has a plurality of regions where the error rates are different from each other.

### Various Modifications

The example has hither been described in which the substrates 1 (the white substrate 1 and the blue substrate 1) on which the solders for soldering mounted components are formed is used as the measurement object 1. However, the measurement object 1 is not limited thereto. Another example of the measurement object 1 includes a substrate in which an adhesive for adhering a mounted component is formed. Further, examples of the measurement object 1 include a wiring substrate in which a wiring pattern is formed, a substrate in which a land is formed, a substrate in which glass is printed, and a substrate in which a fluorescent substance is printed. Furthermore, examples of the measurement object 1 include a substrate in which ink such as nano-silver ink, polyimide ink, carbon nano-tube ink is printed, a substrate in which silk printing is performed, and a glass substrate (TFT (Thin Film Transistor) in which an aluminum electrode is formed.

Another example of the above-described measurement object 1 includes a substrate that has another region (second region) (for example, a region where an adhesive, a wiring pattern, a land, glass, ink, or the like is formed) where an error rate is different from that of the substrate region 2 as well as the substrate region 2 (first region). The three-dimensional measuring apparatus 100 can determine the measurement illuminance based on two error rates, that is, an error rate of the substrate selection region 4 designated from the substrate region 2 and an error rate of a selection region designated from the region other than the substrate region 2.

The case has hitherto been described in which the measurement illuminance is determined based on two different error rates. Of course, the three-dimensional measuring apparatus 100 may determine measurement illuminance based on the error rates of three or more selection regions designated from three or more regions where error rates are different from each other.

The case has hitherto been described in which the phase of the stripe is shifted four times to acquire four images and the phase shift method is applied. However, the embodiment of the present disclosure can be applied, when the number of shifts of the phase and the number of images are three or more.

The control unit 16 may display the graphs or the tables shown in FIGS. 10 to 13 on the display unit 18, when the control unit 16 calculates the error rate of the substrate selection region 4, the error rate of the solder selection region 5, or the like. Further, the control unit 16 may perform a process of highlighting and displaying a portion corresponding to the measurement illuminance in a graph or a table, when the control unit 16 determines the measurement illuminance. Thus, the user can easily recognize the measurement illuminance when the user views the graph or the table displayed on the display unit 18.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A three-dimensional measuring apparatus comprising:
a projecting unit that includes an illumination capable of varying illuminance and that projects a stripe to a measurement object with light from the illumination and shifts a phase of the stripe projected to the measurement object;
an imaging unit that captures an image of the measurement object to which the stripe is projected; and
a control unit that allows the imaging unit to capture a plurality of the images by allowing the projecting unit to shift the phase of the stripe projected to the measurement object a plurality of times, extracts luminance values from the plurality of captured images, calculates an error rate in three-dimensional measurement of the measurement object based on the extracted luminance values, calculates the error rate for each illuminance by varying the illuminance of the illumination, and determines measurement illuminance for three-dimensionally measuring the measurement object based on the calculated error rate of each illuminance.

2. The three-dimensional measuring apparatus according to claim 1,
wherein the measurement object includes a first region and a second region where the error rate is different from that of the first region, and
wherein the control unit calculates first and second error rates, which are the error rates of the first and second regions, respectively, for each illuminance by varying the illuminance of the illumination and determines the measurement illuminance based on the calculated first and second error rates of each illuminance.

3. The three-dimensional measuring apparatus according to claim 2, wherein the control unit calculates a sum of the first and second error rates for each illuminance and determines the measurement illuminance based on the sum of the first and second error rates of each illuminance.

4. The three-dimensional measuring apparatus according to claim 3, wherein the control unit determines an illuminance range in which the sum of the first and second error rates is less than a predetermined threshold value and determines an intermediate value of the illuminance range as the measurement illuminance.

5. The three-dimensional measuring apparatus according to claim 3, wherein the control unit determines the measurement illuminance based on a variation ratio of the sum of the first and second error rates to the variation in the illuminance.

6. The three-dimensional measuring apparatus according to claim 3, wherein the control unit determines the illuminance for which the sum of the first and second error rates is minimum as the measurement illuminance.

7. The three-dimensional measuring apparatus according to claim 3, wherein the control unit prioritizes one of the first and second error rates by multiplying at least one of the first and second error rates by a weight coefficient, and then calculates the sum of the first and second error rates.

8. The three-dimensional measuring apparatus according to claim 1, wherein the control unit calculates a difference between the illuminance values, which are extracted from the plurality of images captured by shifting the phase of the stripe and correspond to the same pixel among the plurality of images, determines whether the calculated difference between the luminance values is less than a first threshold value, and calculates a ratio of the pixels, at which the difference between the luminance values is less than the first threshold value, as the error rate.

9. The three-dimensional measuring apparatus according to claim 8, wherein the control unit determines whether at least one of the luminance values, which are extracted from the plurality of images and correspond to the same pixel among the plurality of images, is equal to or greater than a second threshold value and calculates a ratio of the luminance values equal to or greater than the second threshold value as the error rate.

10. The three-dimensional measuring apparatus according to claim 1, wherein the control unit determines whether at least one of the luminance values, which are extracted from the plurality of images captured by shifting the phase of the stripe and correspond to the same pixel among the plurality of images, is equal to or greater than a predetermined threshold value and calculates a ratio of the luminance values equal to or greater than the threshold value as the error rate.

11. A three-dimensional measuring method comprising:
projecting a stripe to a measurement object with light from an illumination capable of varying illuminance of the light;
capturing a plurality of images by shifting a phase of the stripe projected to the measurement object a plurality of times;
extracting luminance values from the plurality of captured images;
calculating an error rate in three-dimensional measurement of the measurement object based on the extracted luminance values;
calculating the error rate for each illuminance by varying the illuminance of the illumination; and
determining measurement illuminance for three-dimensionally measuring the measurement object based on the calculated error rate of each illuminance.

12. A program causing a three-dimensional measuring apparatus to perform:
projecting a stripe to a measurement object with light from an illumination capable of varying illuminance of the light;
capturing a plurality of images by shifting a phase of the stripe projected to the measurement object a plurality of times;
extracting luminance values from the plurality of captured images;
calculating an error rate in three-dimensional measurement of the measurement object based on the extracted luminance values;
calculating the error rate for each illuminance by varying the illuminance of the illumination; and
determining measurement illuminance for three-dimensionally measuring the measurement object based on the calculated error rate of each illuminance.
